(19) United States
(12) Patent Application Publication
(10) Pub. No.: US 2024/0243644 A1
(43) Pub. Date: Jul. 18, 2024

(54) Methods and Apparatus for Producing a Planar Structure

(71) Applicant: Siemens Aktiengesellschaft, München (DE)

(72) Inventors: Thomas Soller, Deggendorf (DE); Carsten Schuh, Baldham (DE); Stefan Denneler, München (DE)

(73) Assignee: Siemens Aktiengesellschaft, München (DE)

(21) Appl. No.: 18/558,790

(22) PCT Filed: Mar. 10, 2022
(86) PCT No.: PCT/EP2022/056212

§ 371 Date: Nov. 3, 2023

(30) Foreign Application Priority Data
May 5, 2021 (EP) 21172177.4

(51) Int. Cl. H02K 15/02

(52) U.S. Cl. CPC H02K 15/02

(57) ABSTRACT

Various embodiments include a method for producing a planar structure including: printing a green body of the structure using a screen printing process on a surface of a carrier substrate; generating a temperature gradient on the surface underneath the green body; removing the green body from the carrier substrate; and heat treating the green body in order to convert the green body into the planar structure. The temperature gradient is at least 0.5 K/mm along a plane of the surface and has an extent in the plane of at least 10 mm.

### CROSS-REFERENCE TO RELATED APPLICATIONS

This application is a U.S. National Stage Application of International Application No. PCT/EP2022/056212 filed Mar. 10, 2022, which designates the United States of America, and claims priority to EP Application No. 21172177.4 filed May 5, 2021, the contents of which are hereby incorporated by reference in their entirety.

### TECHNICAL FIELD

The present disclosure relates to fabrication. Various embodiments of the teachings herein include apparatus and/or methods for producing a planar structure.

### BACKGROUND

Screen printing or stencil printing may be used for the production of planar structures, such as for example magnetic laminations for electric machines. In this case, starting from metal powders, a printing paste is first produced, and this is then processed by means of a screen and/or stencil printing technique to give a thick layer of a green body and then the resulting green body is transformed by thermal treatment such as debindering and sintering into a metallically structured component, hereinafter referred to as planar structure. Such a planar structure may, for example, be an electrical steel sheet, with stacking of a plurality of these electrical steel sheets resulting in a stack of magnetic laminations for an electric machine. A method of this type is described, for example, in WO 2020/099052A1.

In the forming step using the screen or stencil printing process, the green body is printed onto a carrier substrate, with a good wetting and hence adhesion of the printing paste on the substrate being desirable in order to ensure a defect-free print image. Before the thermal processing, the green body must then be detached from the carrier substrate. The release of the bond between the carrier and the green body is a critical process step insofar as the typically approx. 100 μm thick green body can easily suffer damage in the event of an excessively large or disadvantageous action of force.

In addition to its functional constituents, for example the iron particles, the green body essentially comprises a polymer-based matrix and filler particles, meaning that although it is handleable per se, it does exhibit a certain degree of sensitivity. Thus, it is easily possible by way of the mechanical stresses introduced to induce cracks, which are disadvantageous in the further process sequence with regard to the dimensional stability or the defect-free nature of the resulting planar structure.

### SUMMARY

The teachings of the present disclosure include process technology that is more reliable compared to the prior art, and may reduce the reject rate when producing planar structures. For example, some embodiments include a method for producing a planar structure (2) comprising: printing a green body (6) of the structure (2) using a screen printing process (4) on a surface (8) of a carrier substrate (10), removing the green body (6) from the carrier substrate (10), and heat treating the green body in order to convert the green body into the planar structure, characterized in that the temperature of the carrier substrate (10) is controlled such that a temperature gradient (14) is generated on its surface (8) underneath the green body (6), which is at least 0.5 K/mm along a surface plane (16), and has an extent (17) in the surface plane (16) of at least 10 mm.

In some embodiments, the temperature gradient (14) extends over the surface (8) covered by the green body (6).

In some embodiments, the temperature gradient (14) alternates and, after an extent of at least 10 mm in the surface plane (16), a second temperature gradient (14′) is generated, which runs with an opposite sign to the first temperature gradient (14).

In some embodiments, an adhesion-promoting layer (18) is applied between the surface (8) and the green body (6).

In some embodiments, the surface (8) of the carrier substrate (10) has a mean roughness Ra which is less than 0.5 μm.

In some embodiments, the mean roughness Ra is less than 0.2 μm, or less than 0.09 μm.

In some embodiments, temperature control elements (20) for generating the temperature gradient (14) are arranged beneath the carrier substrate.

In some embodiments, the temperature control elements (20) are Peltier elements (22).

In some embodiments, after printing the green body (6), a step (24) of drying the green body (6) on the carrier substrate (10) is effected.

In some embodiments, wherein a plurality of planar structures (2) produced by means of a method as described herein are stacked on top of one another to form a three-dimensional structure (26).

In some embodiments, the three-dimensional structure (26) is a laminated core (28) for an electric machine.

As another example, some embodiments include an apparatus for performing a method as described herein, comprising a carrier substrate (10) having a surface (8) for applying a green body (6) by means of a screen printing process (4) and a substrate bottom side (30) opposite the surface (8), wherein temperature control elements (20) are arranged on or in the substrate bottom side (30).

In some embodiments, temperature control elements are Peltier elements (22) or fluid channels (32).

### BRIEF DESCRIPTION OF THE DRAWINGS

Further details of the teachings herein and further features are elucidated in more detail with reference to the following figures. In the figures:

FIGS. 1a-1c show a basic schematic sequence for the production of a planar structure,

FIGS. 2a, 2b show two possible embodiments of box II in FIG. 1a) in a more detailed form,

FIG. 3 shows a plan view of a carrier substrate with a screen printing stencil,

FIG. 4 shows a plan view of a carrier substrate with a green body printed thereon and the representation of a temperature gradient,

FIG. 5 shows an analogous representation in accordance with FIG. 4 with temperature gradients of a different form,

FIG. 6 shows an analogous representation in accordance with FIG. 4 with temperature gradients of radial form,

FIG. 7 shows a three-dimensional representation of a typical planar structure,

FIG. 8 shows a three-dimensional structure made up of a plurality of planar structures in the form of a laminated core for an electric machine,

FIG. 9 shows a laminated core similar to that in FIG. 8 mounted on a shaft as a rotor for an electric machine.

### DETAILED DESCRIPTION

An example method incorporating teachings of the present disclosure comprises: printing a green body of the structure by means of a screen printing process on a surface of a carrier substrate, removing the green body from the carrier substrate, and heat treating the green body in order to convert the green body into the planar structure. The temperature of the carrier substrate is controlled such that a temperature gradient is generated on its surface underneath the green body, which is at least 0.5 K/mm along a surface plane and has an extent in the surface plane of at least 10 mm.

A planar structure is an essentially flat, sheet-like structure, which is substantially larger in its extent in a plane of extension than in its height. A green body is a preliminary body for a later heat treatment. A green body is per se generally mechanically self-supporting and can be mechanically loaded to a limited extent. By way of the heat treatment, in particular in the form of a sintering process in which, unlike in a melting process, individual grains in the green body form a cohesive, materially bonded structure via diffusion processes, the green body is transformed into a sintered body. After the described heat treatment and the associated mechanical consolidation, the term planar structure is used.

A screen printing process is a process in which a paste is applied for example by means of a squeegee to a substrate, to form a layer which usually has a thickness lying in the range between 70 μm and 150 μm. The paste is printed onto the substrate only on certain uncovered regions that are kept free by means of a stencil. The paste is typically printed through a screen, but this is not absolutely necessary. Stencil printing without the use of a screen is also subsumed under the term “screen printing process”.

A carrier substrate is a self-supporting structure having a surface that is as smooth as possible. The surface is provided for the purpose of printing the green body thereon, with it optionally being possible for a further thin layer, for example in the form of an adhesion-promoting layer, to be applied between the surface and the green body. In the latter case, too, the green body is said to have been printed onto the surface of the carrier substrate. In addition to a substrate body having the surface described, the carrier substrate may also have further elements such as a frame, a carrier plate and/or temperature control elements, these being assembled together appropriately. The surface of the carrier substrate extends in a surface plane that is as planar as possible.

The teachings herein make it possible to reliably and cleanly detach the green body from the carrier substrate. As a result of the temperature gradient along the surface plane between the green body and the surface of the carrier substrate, tensile and/or compressive and/or shear stresses are generated due to the differing coefficients of thermal expansion of the substrate and of the green body, and these assist detachment of the green body from the substrate. The intensity of these tensile, compressive and shear stresses is chosen via the value ranges described with regard to the temperature gradient and with regard to the extent thereof in such a way that they specifically assist detachment of the green body from the surface but do not generate any damage to the green body as such.

In some embodiments, the temperature gradient extends over a distance of at least 10 mm. There are various options for configuring this temperature gradient. On the one hand, it is technically feasible for the temperature gradient to run as far as possible over the entire surface plane of the carrier substrate underneath the green body. There is therefore one starting point, for example the point at which the green body on the carrier substrate starts its planar extension, and the temperature gradient is allowed to run up to the opposite end of the green body. For example, if the green body has an extent of 200 mm, the temperature gradient over the extent described has an absolute magnitude of 100 K. The tensile, compressive and shear stresses that over this temperature range arise underneath the green body are suitable for detaching it. In principle, temperature gradients between 70 K and 150 K are readily suited to achieving the described effect.

However, if by its nature the green body is more sensitive to the described tensile, compressive, and/or shear stresses, it may be expedient to generate an alternating temperature gradient over the course of the green body in the surface plane. This alternating temperature gradient should thus amount to at least 10 mm and after at least a further 10 mm (i.e. after at least 20 mm of total extension) continue with an opposite sign, until it can again assume the original sign after, for example, a further 10 mm. In this way, local tensile, compressive and shear stresses are induced due to the differing coefficients of expansion, while keeping the absolute temperature gradient comparatively small. In particular in the case of green bodies of large areal form, this prevents excessively high absolute temperature fluctuations from arising along the temperature gradient, which may possibly already influence the internal properties of the green body. In the case of alternating temperature gradients, the cited 10 mm intervals are a lower limit within which the desired effect can still be achieved in a technically readily feasible manner. These can also be chosen to be higher, and especially with alternating temperature gradients these can also be higher than the described 0.5 K/mm, for example can be 1 K/mm.

In some embodiments, the surface of the carrier substrate has a mean roughness Ra which is less than 0.5 μm, less than 0.2 μm, or less than 0.09 μm. The abbreviation Ra for the arithmetic mean roughness value (also mean roughness) is standardized according to DIN EN ISO 4287:2010. In order to ascertain this measured value, the surface is scanned over a defined measurement section and all height and depth differences of the surface are recorded. After calculating the definite integral of this roughness curve over the measurement section, this result is lastly divided by the length of the measurement section.

A very smooth surface of the carrier substrate assists the removability of the green body from the surface in addition to the cited measures using a temperature gradient. The finer the surface, the easier it is to remove the green body. On the other hand, it is also necessary that, when printing the printing paste, the latter also adheres to the surface of the carrier substrate, and therefore it is expedient to apply an adhesion-promoting layer between the surface of the carrier substrate and the green body to be printed thereon. Against this background, the green body is printed onto the surface of the carrier substrate also include cases in which the described adhesion-promoting layer is arranged between the surface of the carrier substrate and the green body.

In some embodiments, to generate the temperature gradient, temperature control elements may be arranged beneath the carrier substrate. In some embodiments, these temperature control elements are Peltier elements. In principle, however, it may also be expedient to arrange channels underneath the carrier substrate or in the lower region of the carrier substrate, in which channels flows a fluid for controlling the temperature of the carrier substrate.

In some embodiments, after printing the green body, the method includes drying the green body on the carrier substrate to be effected. Drying the green body on the carrier substrate also facilitates the removal of the green body and may provide an advantage over drying after removal of the green body.

In some embodiments, a plurality of planar structures are produced by the method described and these are stacked on top of one another to form a three-dimensional structure. This is particularly expedient for the construction of a laminated core for an electric machine. In this case, the planar structures are designed as magnetic laminations.

Some embodiments include an apparatus for performing one or more of the methods described herein. An example apparatus comprises a carrier substrate having a surface for applying a green body by means of a screen printing process and a substrate bottom side opposite the surface, wherein temperature control elements are arranged on or in the substrate bottom side. The apparatus described has the same advantages as have already been stated in relation to the methods elucidated above. In some embodiments, the temperature control elements are designed in the form of Peltier elements or in the form of fluid channels.

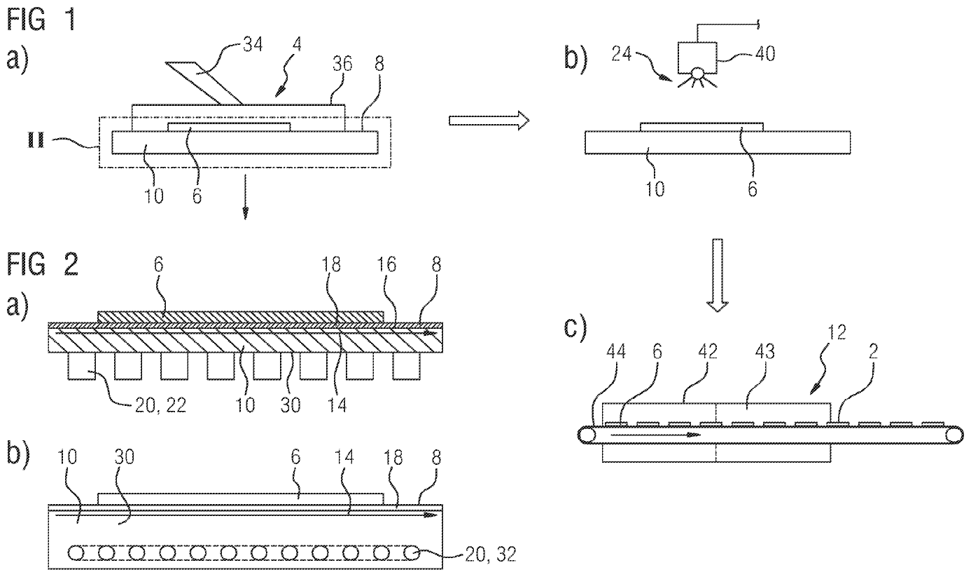

In FIG. 1, individual method elements for producing a planar structure 2 are represented in the sub-figures a), b) and c). In FIG. 1a), a screen printing process 4 is described schematically, wherein a green body 6 is printed onto a carrier substrate 10 by means of a squeegee 34. Here, a printing paste (not represented here) is pressed by the squeegee 4 through a printing stencil 38 (cf. FIG. 3), so that the green body 6 adheres to a surface 8 of the carrier substrate. The printing stencil 38 is mounted in a printing frame 36 in accordance with FIG. 3, it being possible for a screen to be clamped into the printing frame 36, this not being represented here. The screen (not represented here) serves to distribute the printing paste uniformly over the surface 8 of the carrier substrate 10. Whether or not a screen is used depends on the rheological properties of the printing paste. Therefore, the term “stencil printing” is subsumed here in general under the generic term “screen printing”.

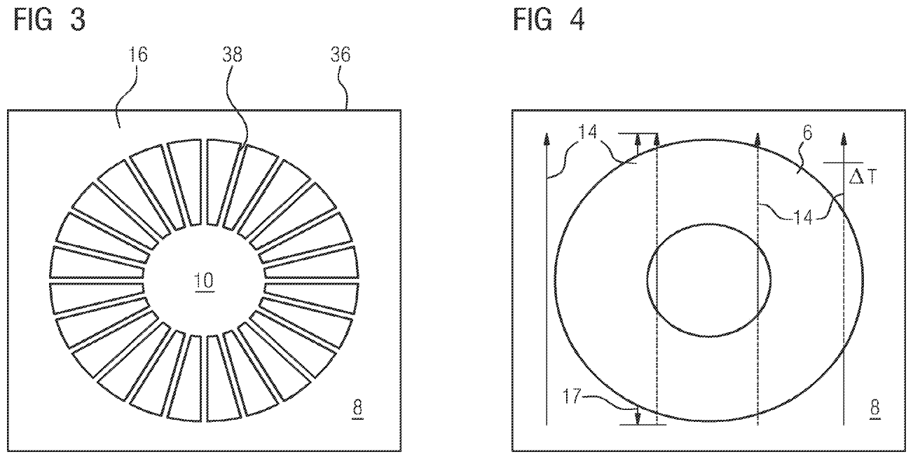

On the one hand, the teachings of the present disclosure may simplify the separation of the printed green body. On the other hand, there is however also the need for the green body to adhere well to the surface 8 of the substrate when being printed on. For this purpose, depending on the printing paste, an adhesion-promoting layer 18 is often applied (cf. FIGS. 2a) and 2b)). The surface 8 in this embodiment is a polished metal surface which has a mean roughness Ra of 0.3 μm.

In addition, according to FIG. 1b), a drying step 24 is performed, where in this embodiment a drying apparatus 40 is placed above the carrier substrate 10 with the green body 6. The drying apparatus 40 may for example be an infrared heater.

In FIG. 1c), a heat treatment furnace in the form of a continuous furnace 42 is further represented schematically. The continuous furnace 42 has a heating chamber 43, through which the green bodies 6 detached from the carrier substrate are conveyed on a conveyor belt 44 and in the process are subjected to a heat treatment process in the form of a sintering process. After the green bodies 6 have left the heating chamber 43 they are referred to as planar structures 2. The continuous furnace 42 may also include regions that are at a lower temperature and can contribute to debindering or additional drying of the green body.

Between the sub-FIGS. 1b) and 1c), the green body 6 is detached from the surface 8 of the carrier substrate 10. The means for detaching the green body 6 are considered in FIG. 2 with two different alternatives. Temperature control elements 20 are fitted on or in a substrate bottom side 30 of the carrier substrate 10. In FIG. 2a), the temperature control elements 20 are designed in the form of Peltier elements 22, which are arranged on the bottom side 30. Each of the Peltier elements 22 can be controlled in such a way that a very specific temperature can be introduced by it to the carrier substrate 10 and further on its surface 8 or viewed perpendicular to the carrier substrate 10 to the surface plane 16 thereof. Since each Peltier element 22 can generate a different temperature by means of electrical control, it is possible to produce a temperature gradient 14 in the surface plane 16. The different temperature gradients 14 and the form thereof are elucidated by way of example in FIGS. 4-6.

In some embodiments, the temperature control elements 20 (as shown in FIG. 2b) comprise fluid channels 32. The fluid channels 32 are integrated in the bottom side 30 of the carrier substrate 10. The fluid channels 32 run for example in a meandering or circular manner, depending on the form of the temperature gradient 14. Thus, for example, a temperature gradient 14 can be generated by introducing a fluid with a certain temperature into the fluid channel 32, since the fluid continuously emits heat to the carrier substrate 10 when passing through the meandering fluid channel 32 and thus increasingly has a lower temperature. In principle, however, it is also expedient to introduce a plurality of separate channel systems of fluid channels 32 in order to feed in fluids with different temperatures in a targeted manner and thus to generate the temperature gradient 14 in the surface plane 16.

FIG. 4 shows a form of the representation of the temperature gradient 14. The temperature gradient 14 runs in the surface plane 16 of the carrier substrate 10 from one end of the green body 6 to its other end. This is a single targeted direction of extension of the temperature gradient 14. With relatively small diameters or dimensions of the green body 6, a relatively high absolute temperature gradient over the entire surface plane 16 can be achieved with a temperature gradient of 0.5 K/mm (temperature gradients of between 70 K and 150 K can be sought in this case). If, for example, the green body 6 has a diameter of 150 mm, then the temperature gradient 14 over its dimension 17 is 75° C. with a gradient of 0.5 K/mm.

If the temperature of the surface 8 beneath the green body 6 at the start of the temperature gradient is for example 20° ° C., it is a temperature of 95° C. at the opposite end. Both temperatures are suitable for bringing about appropriate tensile, compressive or shear stresses due to the differing coefficients of expansion of the carrier substrate 10 and the green body 6 and for facilitating detachment of the green body 6 from the carrier substrate 10. For the same green body, the absolute magnitude of the temperature difference is 105 K if the temperature gradient 14 is 0.7 K/mm.

Furthermore, the stated temperature gradient 14 and the absolute temperatures arising here are harmless for the mechanical properties of the green body 6. However, if the green body is larger, for example 250 mm in diameter, with a gradient of 0.5 K/mm a temperature difference of 175° C. is formed. This could already lead to changes in the structure of the green body.

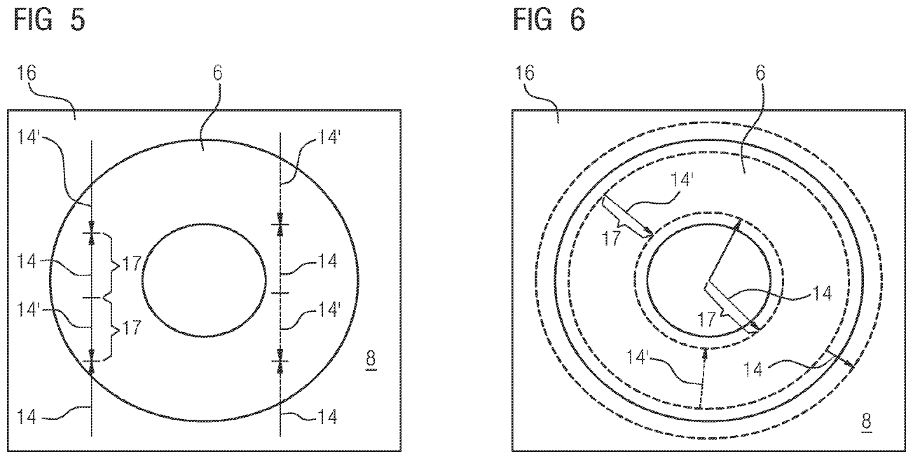

In this case, it may be expedient to apply an alternating temperature gradient 14, 14′ according to FIG. 5, having an extent of between 10 and 20 mm in each case and then continuing in the same direction with changed signs as shown in FIG. 5. This alternating temperature gradient 14, 14′ reduces the absolute temperature differences on the substrate surface 8 and thus the thermal loading of the green body 6 remain lower. If the extent 17 of the gradient 14 or 14′ is 30 mm, an absolute temperature difference of 30° K prevails.

This temperature gradient 14 and 14′ according to FIG. 5 can of course also be increased, so that in the extent 17 described here a temperature gradient in the range between 70 and 150° C. is also formed, for example when the temperature gradient is 4 K/mm. The design of the temperature gradient 14 and 14′ can in all of the examples described here always be adapted based on the coefficients of expansion of the material used for the carrier substrate 10 and the green body 6 produced. The material used for the carrier substrate is typically a polished metal disk, for example a stainless steel disk.

An alternative example of the temperature gradient 14 and 14′ is represented in FIG. 6. This temperature gradient 14 and 14′ is designed in an alternating fashion as in FIG. 5, but in the form of concentric circles running from the center of the green body to the outside thereof.

The described temperature gradients assist the reliable separation of the green body 6 from the substrate. However, in addition, mechanical assistance is generally also required. The separation of the green body 6 from the surface 8 of the carrier substrate 10 can be assisted not only by the temperature gradient 14 described but also by further aids, by way of example a vacuum gripper or an electromagnetic gripper and also by a suction roller or by a peeling device such as for example a wire or a knife.

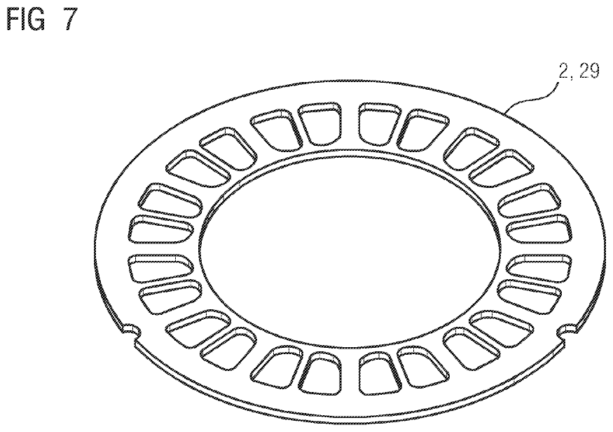

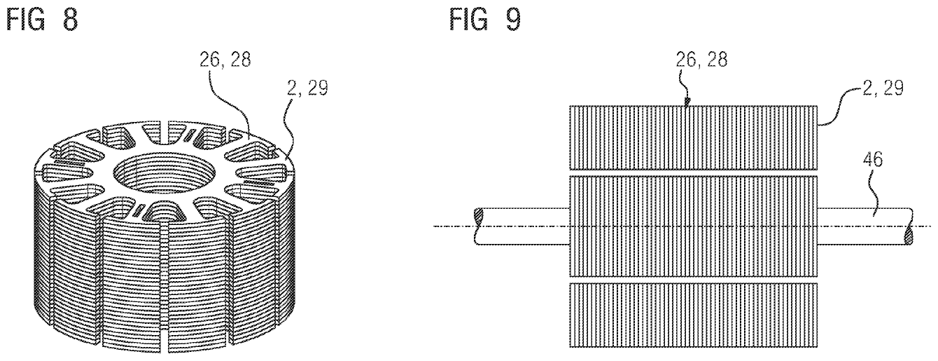

FIG. 7 shows by way of example a planar structure 2 produced by the method described, which is designed in the form of a magnetic lamination 29. A plurality of these magnetic laminations 29 is, as shown in FIG. 8, stacked together to form a three-dimensional structure 26 in the form of a laminated core 28. Such a laminated core 28 can in turn be mounted on a shaft 46 and thus forms the rotor of an electric machine (not represented).

### LIST OF REFERENCE SIGNS

2 planar structure
4 screen printing process
6 green body
8 surface
10 carrier substrate
12 heat treatment
14 temperature gradient
16 surface plane
17 temperature gradient extent
18 adhesion-promoting layer
20 temperature control elements
22 Peltier element
24 drying step
26 three-dimensional structure
28 laminated core
29 magnetic lamination
30 substrate bottom side
32 fluid channels
34 squeegee
36 printing frame
38 printing stencil
40 drying apparatus
42 continuous furnace
43 heating chamber
44 conveyor belt
46 shaft

What is claimed is:

1. A method for producing a planar structure comprising:
printing a green body of the structure using a screen printing process on a surface of a carrier substrate;
generating a temperature gradient on the surface underneath the green body;
removing the green body from the carrier substrate; and
heat treating the green body in order to convert the green body into the planar structure;
wherein the temperature gradient is at least 0.5 K/mm along a plane of the surface and
has an extent in the plane of at least 10 mm.

2. The method as claimed in claim 1, wherein the temperature gradient extends over all of the surface covered by the green body.

3. The method as claimed in claim 1, wherein the temperature gradient alternates and, after an extent of at least 10 mm in the surface plane, a second temperature gradient runs with an opposite sign to the first temperature gradient.

4. The method as claimed in claim 1, further comprising applying an adhesion-promoting layer between the surface and the green body.

5. The method as claimed in claim 1, wherein the surface of the carrier substrate has a mean roughness Ra less than 0.5 μm.

6. The method as claimed in claim 5, wherein the mean roughness Ra is less than 0.2 μm.

7. The method as claimed in claim 1, wherein temperature control elements to generate the temperature gradient are arranged beneath the carrier substrate.

8. The method as claimed in claim 6, wherein the temperature control elements comprises Peltier elements.

9. The method as claimed in claim 1, further comprising, after printing the green body, drying the green body on the carrier substrate.

10. A method for generating a three-dimensional structure,
printing a green body of the structure using a screen printing process on a surface of a carrier substrate;
generating a temperature gradient on the surface underneath the green body;
removing the green body from the carrier substrate; and
heat treating the green body in order to convert the green body into the planar structure;
wherein the temperature gradient is at least 0.5 K/mm along a plane of the surface and has an extent in the plane of at least 10 mm;
generating a multiplicity of planar structures; and
stacking the planar structures on top of one another to form a three-dimensional structure.

11. The method as claimed in claim 10, wherein the three-dimensional structure comprises a laminated core for an electric machine.

12. An apparatus comprising:
a carrier substrate having a top surface for applying a green body using a screen printing process and a bottom side opposite the top surface; and
temperature control elements arranged on or in the substrate bottom side to generate a temperature gradient on the surface underneath the green body;
wherein the temperature gradient is at least 0.5 K/mm along a plane of the surface and has an extent in the plane of at least 10 mm.

13. The apparatus as claimed in claim 12, wherein temperature control elements are comprise Peltier elements or fluid channels.
